(19) United States
(12) Patent Application Publication
(10) Pub. No.: US 2005/0086414 A1
(43) Pub. Date: Apr. 21, 2005

(54) Integrated circuit capable of working with multiple bus interface standards

(76) Inventor: Dominik J. Schmidt, Palo Alto, CA (US)

Correspondence Address: DOMINIK J. SCHMIDT, P.O. BOX 20541, STANDFORD, CA, 94309, US

(21) Appl. No.: 10/690,263

(22) Filed: Oct. 21, 2003

(51) Int. Cl. G06F 13/36

(52) U.S. Cl. 710/315

(57) ABSTRACT

An interface circuit that conforms to multiple bus standards includes a first interface circuit conforming to a first bus standard; a second interface circuit conforming to a second bus standard; and a common set of pins coupled to the first interface circuit and the second interface circuit, the common set of pins being user selectable to communicate with a host computer bus in accordance with either the first bus standard or the second bus standard.

### BACKGROUND

The present invention relates to an interface circuit conforming to multiple bus standards.

The spiraling performance of computers have been achieved in part through high performance peripheral devices such as video graphics adapters, local area network interfaces, SCSI bus adapters, full motion video, redundant error checking and correcting disk arrays, and the like that communicate over high speed expansion local buses. Desktop computers (and servers) are usually constructed differently from mobile computers in that more of their constituent subsystems are provided through add-in boards and/or add-on devices outside the system motherboard. This arrangement makes it easy to tailor the system's capabilities by mixing and matching a specific set of desired functions. This customizing capability allows desktop PC vendors to differentiate their products from those of other manufacturers, as well as allowing users to fine-tune a standard-model desktop to their particular functional needs. Virtually all computers communicate with peripherals through a high speed expansion local bus standard called the “Peripheral Component Interconnect” or PCI bus. A more complete definition of the PCI local bus may be found in the PCI Local Bus Specification, revision 2.1; PCI/PCI Bridge Specification, revision 1.0; PCI System Design Guide, revision 1.0; and PCI BIOS Specification, revision 2.1, the disclosures of which are hereby incorporated by reference. These PCI specifications are available from the PCI Special Interest Group, P.O. Box 14070, Portland, Oreg. 97214.

Mobile platform customization is more difficult than in a desktop, because of the integration of many system components into the (pre-determined) system configuration. Some means is needed to augment or perhaps replace the basic platform's components; that is, an add-in or add-on capability is needed. For mobile computers, the PCMCIA (Personal Computer Memory Card International Association) has specified a bus standard called a PC-Card standard that provides an I/O interface for a 68 pin connector initially used for memory cards. Variations of the PCMCIA bus include the CardBus and Zoomed Video Specifications. The connector supports a 32-bit address/data path, which provides the same high performance levels as the host platform's internal PCI system bus. CardBus provides a 32-bit multiplexed address/data path, which operates at PCI local-bus speeds of up to 33 MHz, yielding a peak band-width of 132 MB/sec. CardBus accomplishes this by adopting the synchronous burst-transfer orientation of PCI, as well as a bus protocol which is essentially identical to that of PCI. CardBus also shares the PCI software standardization namely header files used in hardware configuration at boot time and/or dynamically during run-time hardware usage. CardBus devices can be power managed similarly to PCI devices through BIOS and power management interfaces at the card and socket services level. While CardBus is derived from PCI, it may be implemented on any 32-bit system that provides functionality similar to that provided by PCI. Although it is not the same as PCI in all respects, the signaling protocols are identical. These similarities make it especially easy to link CardBus with PCI, although CardBus is also usable with other system busses.

Traditionally, an add-on card such as a PCI card or a CardBus card contains one or more bus interface integrated circuits (ICs) and one or more ICs that provide the functionality specified for the add-on card. Due to voltage differences between PCI and PCMCIA cards, multiple versions of bus interface ICs need to be designed, inventoried, and supported. To illustrate, to manufacture a PCI compatible add-on card, PCI compatible bus interface ICs are used. To make a CardBus version of the same add-on card, PCI compatible interface ICs are substituted with CardBus compatible bus interface ICs. The output of the bus interface ICs are provided to other ICs that provide the functionality of the add-on board, for instance modem ICs for modem cards, graphic ICs for display adapter boards, and local area network ICs for networking cards.

### SUMMARY

An interface circuit that conforms to multiple bus standards includes a first interface circuit conforming to a first bus standard; a second interface circuit conforming to a second bus standard; and a common set of pins coupled to the first interface circuit and the second interface circuit, the common set of pins being user selectable to communicate with a host computer bus in accordance with either the first bus standard or the second bus standard.

Advantages of the above system may include one or more of the following. The circuit shares the pins of an IC to be field programmed to use a common set of pins to both transmit and receive data conforming to either the PCI bus standard or the PCMCIA bus standard. The system addresses issues such as miniaturization, chip count, and cost. Based on a programmable chip setting, each bus interface pin can be used to communicate over a plurality of bus interface definitions such as PCI and PCMCIA bus definitions. One interface IC can be used to handle multiple bus standards. For example, one IC can handle either the PCI interface or the PCMCIA interface to avoid the need to keep two versions of the same IC in inventory. This reduces pin count and chip count, thus minimizing required board space and manufacturing cost. Moreover, since separate interface circuits are no longer needed to handle differing voltages, the functionality of an add-on board can be integrated onto a single chip, thus further driving down cost for the resulting product. The system provides designers with an opportunity to lower chip counts, and thus reduce board space and cost, by replacing groups of discrete logical devices with a single chip.

The system also accepts various logic level inputs from a bus that conforms to one of a plurality of bus standards (such as PCI or PCMCIA). This is done while reducing normal power consumption associated with receiving the various logic levels. The system can output at a group of pins one set of logic levels and, when configured, can output at the same group of pins a different set of logic levels.

Examples of the more important features of the above system have been summarized rather broadly so that the detailed description may be better understood. There are, of course, additional features of the invention that will become apparent in the detailed description and that will also form the subject matter of the claims that follow.

### BRIEF DESCRIPTION OF THE FIGURES

In order that the features of this invention may be better understood, a detailed description of the invention, as illustrated in the attached drawings, follows:

FIG. 1 shows an exemplary computer.

FIG. 2 shows an exemplary connection between a host computer and an add-on card.

FIG. 3 shows an exemplary multi-voltage input/output buffer.

FIG. 4 shows an exemplary multi-voltage input/output buffer.

FIG. 5 shows an exemplary peripheral circuit using the shared I/O pins of FIG. 2.

Examples of the more important features of this invention have been summarized rather broadly so that the detailed description may be better understood. There are, of course, additional features of the invention that will become apparent in the detailed description and that will also form the subject matter of the claims that follow.

### DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Referring to FIG. 1 there is shown a peripheral device 10 connected to a computer 12. The device 10 can perform any peripheral functions. For example, it can be a wireless communication IC, a solid state storage IC, among others. In the preferred embodiment, it interfaces with a computer 12 in accordance with either the PCI or the PCMCIA standard, depending on a user selectable indication such as an input pin of the device 10 or a bit in a register that can be programmed. In either case, the device 10 receives address signals from the computer 12 on an address bus 14 and control signals on a control bus 18, and in response thereto provides data signals on a data bus 16 to the computer 12. Thus, in the preferred embodiment, the device 10 provides two modes of operation. In one mode of operation, the computer 12 communicates with the device 10 over a PCI bus. In another mode of operation, the device 10 communicates with the computer 12 over a PCMCIA bus.

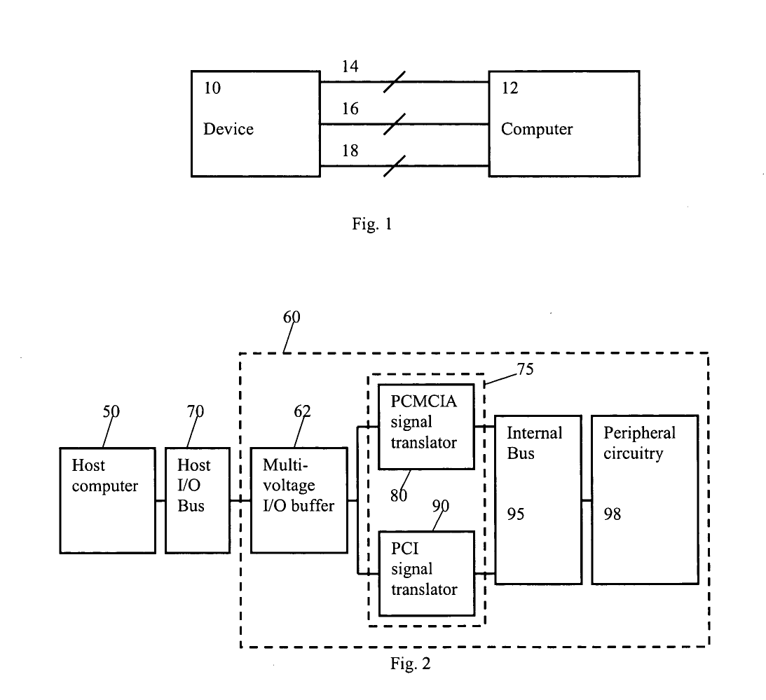

FIG. 2 shows an exemplary connection between a host computer 50 that accepts an add-on card 60 plugged into a host input/output bus 70. Within the add-on card 60, signals from the bus 70 communicate with a plurality of I/O buffers 62. In one embodiment, the I/O buffers 62 are multi-voltage I/O buffers that can handle different voltage levels such as 5 volts, 3 volts, or 1 volt signals, for example. The buffers allow the I/O pins or bi-directional pins to handle an input voltage that is greater than the DC supply voltage for the electronics of the I/O pins. For example, the DC supply voltage can be 3.3V but the device may have to receive an input signal that reaches a value of 5V from another device that has a DC supply voltage of 5V. The circuit accepts various logic level inputs from a bus that conforms to one of a plurality of bus standards (such as PCI or PCMCIA). This is done while reducing normal power consumption associated with receiving the various logic levels. The system can output at a group of pins one set of logic levels (such as PCI levels) and, when configured, can output at the same group of pins a different set of logic levels (such as PCMCIA levels).

The I/O buffers 62 in turn communicate with a signal translator 75 that includes a first signal translator 80, a second signal translator 90, and additional signal translators if needed. The signal translators 80 and 90 are also connected to an internal bus 95 on the card 60. One or more peripheral circuits 98 can be connected to the bus 95 to provide the functionality associated with the add-on card. The peripheral circuits 98 can enhance video, sound, network, or storage capabilities of the host computer 50.

In one embodiment, the first signal translator 80 is a PCI signal translator and the second signal translator 90 is a PCMCIA signal translator. The signal translators 80 and 90 format signals from the bus 95 to conform to the PCI and the PCMCIA bus standards, respectively, so that one set of pins can be selected to handle either PCI or PCMCIA operations. Thus, the signal translator 80 takes signals from the bus 95 and generates PCI control signals and provides the PCI control signals onto predetermined signals lines that are sent to the multi-voltage I/O buffer 62. Similarly, the signal translator 90 takes signals from the bus 95 and generates PCMCIA control signals and provides the PCMCIA control signals onto predetermined signals lines that are sent to the multi-voltage I/O buffer 62. The signal translators 80 and 90 simply pass address and data signal lines through the buffer 62. The control signals, address signals and data signals are then placed onto the host I/O bus 70 and ultimately received by the host computer 50.

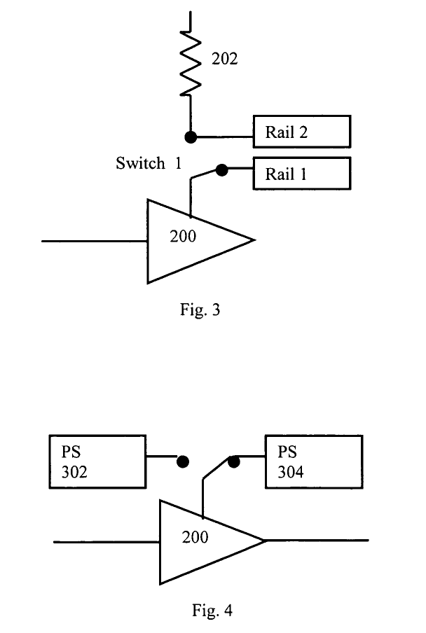

FIG. 3 shows a first embodiment of an exemplary member of a multi-voltage I/O buffer 62. A multi-voltage I/O buffer 200 is provided with its input supply rails tied to one input of a switch SW. The second input of the switch SW is tied to one end of a pull-up resistor 202. The other end of the pull-up resistor 202 is tied to a high voltage supply rail. During operation, the user can select the switch to be in its open or closed state. In its open state, the rail voltage of the buffer 200 rises to a first supply rail voltage, while in its closed state, the rail voltage of the buffer 200 rises to a second supply rail voltage, as determined by the pull-up resistor 202.

FIG. 4 shows a second embodiment of an exemplary multi-voltage I/O buffer 62. In this embodiment, a buffer 300 (which can be unidirectional or bidirectional) has a voltage input connected to a switch SW1. One input of the switch SW1 is connected to a first power supply regulator 302, while the second input of the switch SW1 is connected to a second power supply regulator 304. Switch SW1 toggles between the first and second power supply regulators 302 and 304 to connect the voltage input to different input voltages for the buffer 300. The buffer can be any suitable multi-voltage I/O buffers, an example of which is discussed in U.S. Pat. No. 6,149,319 to Richter, et al.

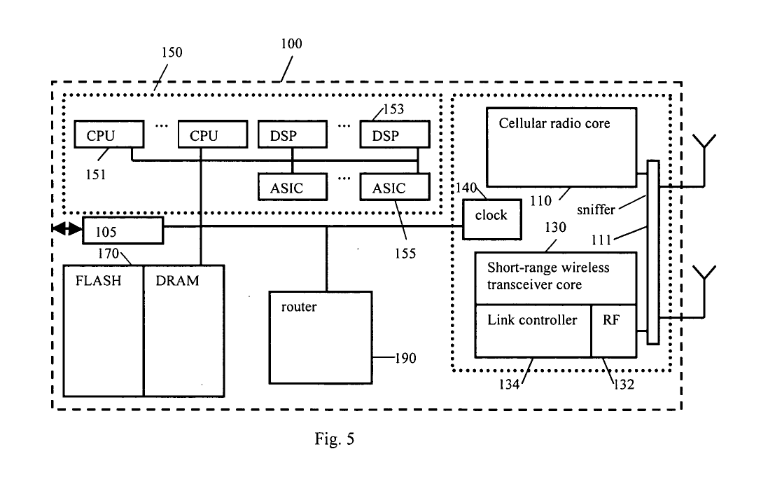

The configuration of the bus protocol that the device is compatible with is user selectable. This allows a peripheral device to be implemented on a chip to minimize cost. FIG. 5 shows a block diagram of a multi-mode wireless communicator device 100 fabricated on a single silicon integrated chip. The chip can be accessed or controlled by a host computer through either a PCI bus interface or a PCMCIA bus interface, both of which sharing one set of pins to conserve pin-out of the chip. In one implementation, the device 100 is an integrated CMOS device with radio frequency (RF) circuits, including a cellular radio core 110, a short-range wireless transceiver core 130, and a sniffer 111, along side digital circuits, including a reconfigurable processor core 150, a high-density memory array core 170, and a router 190. The high-density memory array core 170 can include various memory technologies such as flash memory and dynamic random access memory (DRAM), among others, on different portions of the memory array core. A multi-protocol interface bus 105 is connected to a bus linking the digital circuits so that a host computer can control and/or retrieve received data or transmit data using the wireless communicator device 100.

The reconfigurable processor core 150 can include one or more processors 151 such as MIPS processors and/or one or more digital signal processors (DSPs) 153, among others. The reconfigurable processor core 150 has a bank of efficient processors 151 and a bank of DSPs 153 with embedded functions. These processors 151 and 153 can be configured to operate optimally on specific problems. For example, the bank of DSPs 153 can be optimized to handle discrete cosine transforms (DCTs) or Viterbi encodings, among others. Additionally, dedicated hardware 155 can be provided to handle specific algorithms in silicon more efficiently than the programmable processors 151 and 153. The number of active processors is controlled depending on the application, so that power is not used when it is not needed. This embodiment does not rely on complex clock control methods to conserve power, since the individual clocks are not run at high speed, but rather the unused processor is simply turned off when not needed.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

1. An interface circuit conforming to multiple bus standards, comprising:
a first interface circuit conforming to a first bus standard;
a second interface circuit conforming to a second bus standard; and
a common set of pins coupled to the first interface circuit and the second interface circuit, the common set of pins being user selectable to communicate with a host computer bus in accordance with either the first bus standard or the second bus standard.

2. The interface circuit of claim 1, wherein the common set of pins transmit and receive data conforming to either the PCI bus standard or the PCMCIA bus standard.

3. The interface circuit of claim 1, wherein the first bus standard is a PCI standard.

4. The interface circuit of claim 1, wherein the second bus standard is a PCMCIA standard.

5. The interface circuit of claim 1, further comprising a multi-voltage input output buffer coupled to each pin.

6. The interface circuit of claim 1, further comprising an internal bus coupled to the first and second interface circuit.

7. The interface circuit of claim 6, wherein the first interface circuit formats signals on the internal bus to signals compliant with the first bus standard.

8. The interface circuit of claim 1, wherein the second interface circuit formats signals on the internal bus to signals compliant with the second bus standard.

9. The interface circuit of claim 1, further comprising a first power supply to supply voltage swings in accordance with the first bus standard.

10. The interface circuit of claim 1, further comprising a second power supply to supply voltage swings in accordance with the second bus standard.
